(19) United States
(12) Patent Application Publication
(10) Pub. No.: US 2013/0182457 A1
(43) Pub. Date: Jul. 18, 2013

(54) LIGHTING ASSEMBLY WITH STATIC AUTOSTEREOSCOPIC IMAGE OUTPUT

(71) Applicant: RAMBUS INC., Sunnyvale, CA (US)

(72) Inventor: Timothy A. McCollum, Avon Lake, OH (US)

(73) Assignee: RAMBUS INC., Sunnyvale, CA (US)

(21) Appl. No.: 13/723,424

(22) Filed: Dec. 21, 2012

Related U.S. Application Data
(60) Provisional application No. 61/586,293, filed on Jan. 13, 2012.

(51) Int. Cl. F21V 8/00

(52) U.S. Cl. CPC G02B 6/0068; G02B 6/0073
USPC 362/612; 362/613

(57) ABSTRACT

A lighting assembly includes a light guide in which light propagates by total internal reflection between opposed major surfaces. The light guide receives light generated by two light sources at opposed light input edges of the light guide. The light guide includes light extracting elements that respectively extract light to form a left eye image at a first region and a right eye image at a second region. The left eye and right eye images, when viewed by a viewer, form a static autostereoscopic image.

### RELATED APPLICATION DATA

This application claims the benefit of U.S. Provisional Patent Application No. 61/586,293 filed Jan. 13, 2012, the disclosure of which is herein incorporated by reference in its entirety.

### BACKGROUND

It is possible to present an autostereoscopic three-dimensional image to a viewer by interleaving left and right eye components of the image behind lenticular arrays or parallax barriers. But it is difficult to create an autostereoscopic image using an energy-efficient general lighting assembly.

### BRIEF DESCRIPTION OF THE DRAWINGS

FIG. 1 is a front view of an exemplary lighting assembly that outputs a static autostereoscopic image;

FIG. 2 is a cross-sectional view of the lighting assembly taken along the line 2-2 in FIG. 1;

FIG. 3 is a cross-sectional view of another exemplary lighting assembly;

FIGS. 4 through 7 are enlarged perspective views of exemplary light extracting elements for the lighting assembly; and

FIG. 8 is a cross-sectional view of another exemplary lighting assembly.

### DETAILED DESCRIPTION

Embodiments will now be described with reference to the drawings, wherein like reference numerals are used to refer to like elements throughout. The figures are not necessarily to scale. Features that are described and/or illustrated with respect to one embodiment may be used in the same way or in a similar way in one or more other embodiments and/or in combination with or instead of the features of the other embodiments.

Stereoscopic imaging (also referred to as stereoscopy or 3-D imaging) refers to imaging techniques that create the illusion of depth in an image by presenting two 2-D images taken at different angles of the same scene separately to the left and right eyes of the viewer. The 2-D images are interpreted by the viewer's brain as a single 3-D image having depth. In this disclosure, techniques for producing autostereoscopic static images are described. A static image is an image that is fixed. Therefore, the described autostereoscopic imaging does not relate to the display of 3-D video. Images are described herein as autostereoscopic images because the viewer does not need to wear any specialized equipment, such as glasses with polarized lenses, to perceive them as 3-D images.

Aspects of this disclosure further relate to a lighting assembly that outputs two patterns of light perceived as an autostereoscopic image when a viewer observes the lighting assembly. In one embodiment, the lighting assembly is configured primarily to output the patterns of light perceived as the autostereoscopic image. In another embodiment, the lighting assembly is configured to output light for a primary purpose, such as light for general lighting purposes (e.g., illumination of a space or a surface) and is additionally configured secondarily to output the patterns of light perceived as the autostereoscopic image. In some applications, the lighting assembly is used as an architectural panel or as a sign to display a company name, a company logo and/or other information. In these embodiments, the patterns of light perceived as the autostereoscopic image are output in addition to the light output for the general lighting purpose or the signage purpose. This disclosure, however, will primarily focus on aspects of the lighting assembly that generate the autostereoscopic image since techniques for extracting light from an edge-lit light guide for general lighting purposes or signage purposes are known.

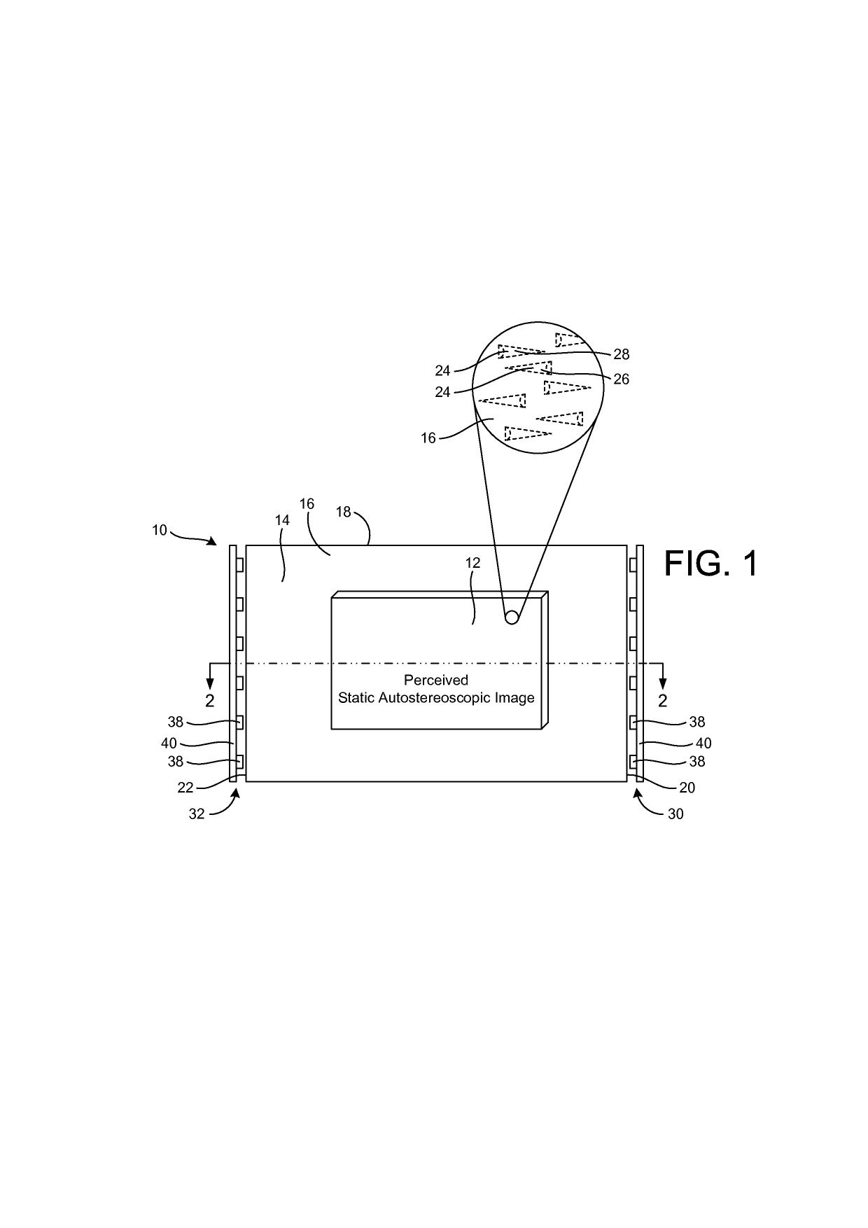

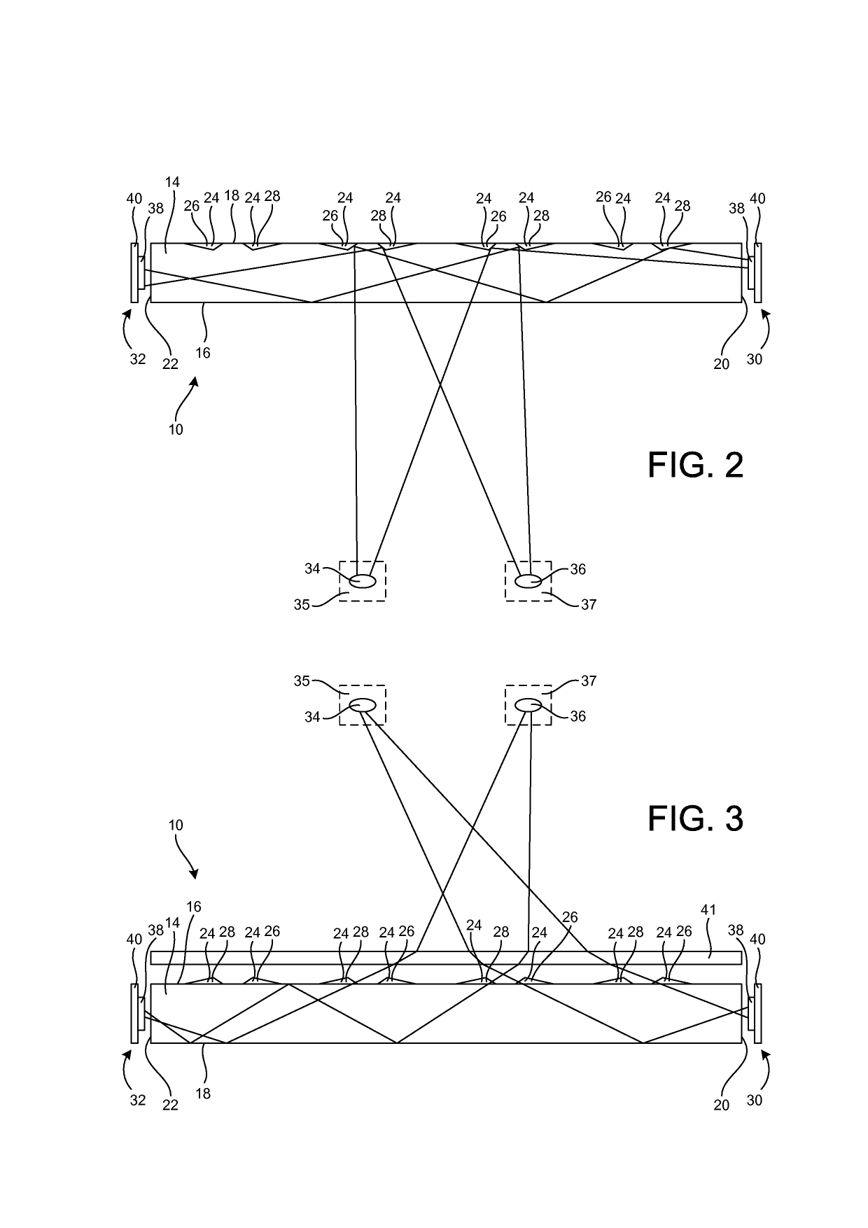

With initial reference to FIGS. 1 and 2, a lighting assembly 10 that outputs patterns of light perceived as a static autostereoscopic image 12 is illustrated. The lighting assembly 10 includes a light guide 14. The light guide 14 has a first major surface 16 and an opposed second major surface 18 between which light propagates by total internal reflection. The light guide 14 also has a first light input edge 20, a second light input edge 22 opposite the first input edge 20, first light extracting elements at at least one of the major surfaces 16, 18, and second light extracting elements at the at least one of the major surfaces 16, 18. In the illustrated embodiment of FIGS. 1 and 2, the light extracting elements (generically represented with reference numeral 24) are at the second major surface 18; and the light extracting elements 24 that are first light extracting elements are indicated by reference numeral 26 and the light extracting elements 24 that are second light extracting elements are indicated by reference numeral 28.

The lighting assembly 10 also includes a first light source 30 that edge lights the light guide 14 through the first light input edge 20 and a second light source 32 that edge lights the light guide 14 through the second light input edge 22. Light from the first light source 30 propagates in the light guide 14 from the first light input edge 20 toward the second light input edge 22. The first light extracting elements 26 are configured to extract light from the first light source 30 through one of the major surfaces (in the illustrated embodiment, the major surface 16) toward a first location 34 as a first pattern of light having a spatial variation of intensity that produces a first image of a stereoscopic pair of images. Similarly, light from the second light source 32 propagates in the light guide 14 from the second light input edge 22 toward the first light input edge 20. The second light extracting elements 28 are configured to extract light from the second light source 32 through the first major surface 16 toward a second location 36 as a second pattern of light having a spatial variation of intensity that produces a second image of the stereoscopic pair of images.

Together, the stereoscopic pair of images is perceived by a viewer as a static autostereoscopic image 12 when the viewer is in position to see the first image with the viewer's left eye and to see the second image with the viewer's right eye. As such, the first image is considered a left eye image and the second image is considered a right eye image.

Light is incident on the first light extracting elements 26 and the second light extracting elements 28 with a range of angles of incidence. Consequently, the pattern of light extracted towards the first location 34 is directed towards a region 35 around the first location 34 and the pattern of light extracted towards the second location 36 is directed towards a second region 37 around the second location 36. The patterns of light will be perceived as an autostereoscopic image by a viewer looking towards the light guide 14 and having one eye within the first region 35 and the other eye within the second region 37. However, the viewer need not observe the light guide 14 from a direction normal to the major surface 16 of the light guide.

The static autostereoscopic image may be an image of, for example, a corporate logo, characters or words, an object, a drawing, or a photograph.

Each light source 30, 32 is typically embodied as one or more solid-state light emitters 38. Exemplary solid-state light emitters 38 include, for example, LEDs (light emitting diodes), laser diodes, and organic LEDs (OLEDs). In an embodiment where the light sources 30, 32 each are one or more LEDs, the LEDs may be top-fire LEDs or side-fire LEDs, and may be broad spectrum LEDs (e.g., emit white light) or LEDs that emit light of a desired color or spectrum (e.g., red light, green light, blue light, or ultraviolet light) or a mixture of broad-spectrum LEDs and LEDs that emit monochromatic light of a desired color. In one embodiment, the light sources 30, 32 emit light with no operably-effective intensity at wavelengths greater than 500 nanometers (nm), i.e., the light sources 30, 32 emit light at wavelengths that are predominantly less than 500 nm. In such embodiments, phosphors (not shown) convert at least part of the light emitted by light sources 30, 32 to longer-wavelength light. The color of the light source 30 may be the same as or different from the light source 32. The light emitters 38 of the light sources 30, 32 are typically mounted on respective printed circuit boards (PCBs) 40.

The light guide 14 is a solid article made from, for example, acrylic, polycarbonate, glass, or another appropriate material. The light guide 14 is typically made from one layer of material, but alternatively may be a multi-layer light guide having two or more layers. In the example shown, the light guide 14 has four edges. Other geometries for the light guide 14 result in a corresponding number of edges. Depending on the geometry of the light guide 12, each edge may be straight or curved, and adjacent edges may meet at a vertex or join in a curve.

The light sources 30, 32 edge light the light guide 14 at the respective light input edges 20, 22. Optical elements (not illustrated), such as homogenizers, lenses, reflectors, light extracting elements, etc., may be present at or adjacent the light input edges 20, 22 to impart one or more corresponding effects on the light entering the light guide 14.

Length and width dimensions of each of the major surfaces 16, 18 are much greater than, typically ten or more times greater than, the thickness of the light guide 14. For instance, in the rectangular embodiment shown in FIGS. 1 and 2, the length (measured from the light input edge 20 to the light input edge 22) and the width (measured along the length of light input edges 20, 22) of the light guide 14 are both much greater than the thickness of the light guide 14. The thickness is the dimension of the light guide 14 in a direction orthogonal to the major surfaces 16, 18. The thickness of the light guide 14 may be, for example, about 0.1 millimeters (mm) to about 10 mm. The light guide 14 may be rigid or flexible and/or may be planar or curved.

The light guide 14 includes the light extracting elements 24 in or on at least one of the major surfaces 16, 18. Light extracting elements 24 that are in or on a major surface 16, 18 will be referred to as being “at” the relevant one of the major surfaces 16, 18. Each light extracting element 24 functions to disrupt the total internal reflection of light principally from only one of the light sources that is incident on the light extracting element 24. In one embodiment, the light extracting elements 24 reflect light principally from only one of the light sources toward the opposed major surface so that the light exits the light guide 14 through the opposed major surface. Alternatively, as shown in FIG. 3, the light extracting elements 24 transmit light principally from only one of the light sources through the light extracting elements and out of the major surface 16 of the light guide 14 having the light extracting elements 24. In this case, a light redirecting film 41 is positioned between the major surface 16 and the locations 34, 36 to redirect the light extracted from the light guide 14 in directions closer to the normal of the major surface 16. In some embodiments, the light redirecting film 41 has a position-dependent light redirecting property that depends on the positional variation in the angle through which the light extracted from the light guide 14 is to be directed towards the regions 35 and 37. In another embodiment, the light extracting elements 24 reflect some of the light and refract the remainder of the light incident thereon. Therefore, the light extracting elements 24 are configured to extract light from the light guide 14 through one or both of the major surfaces 16, 18. The light extracting elements 24 may be at one or both of the major surfaces 16, 18 through which light is emitted, or at the opposite major surface 16, 18.

Light guides having light extracting elements 24 are typically formed by a process such as stamping, molding, embossing, extruding, or another suitable process. Light extracting elements 24 may also be produced by depositing curable material on the light guide 16 and curing the deposited material using heat, UV-light or other radiation. The curable material can be deposited by a process such as printing, ink jet printing, screen printing, or another suitable process.

Variations in the light extracting elements 24 spatially vary the intensity of the light extracted from the light guide to form the first and second patterns of light perceived as the first and second images, respectively. The light extracting elements 24 direct the patterns of light toward the first and second locations 34, 36, respectively. The light extracting elements 24 are configured to extract light with a defined intensity profile and with a defined light ray angle distribution. Intensity profile refers to the variation of intensity with position within an area of the major surface 16, 18 through which light is extracted. Light ray angle distribution refers to the variation of intensity with ray angle of light emitted from an area of the major surface 16, 18 through which light is extracted. Additional light extracting elements (not shown) may be used to output light from the light guide 14 for general lighting purposes and/or for signage purposes.

Exemplary light extracting elements 24 are features of well-defined shape that are small relative to the linear dimensions of the major surfaces 16, 18, and are referred to herein as micro-optical elements. The smaller of the length and width of light extracting element is less than one-tenth of the larger of the length and width of the light guide 14, and the larger of the length and width of the light extracting element is less than one-half of the smaller of the length and width of the light guide 14. The length and width of the light extracting element are measured in a plane parallel to the major surface 16, 18 of the light guide 14 for flat light guides 14 or along a surface contour for non-flat light guides 14.

The light extracting elements 24 are shaped to predictably reflect light or predictably refract light. The light extracting element 24 are elongate and are asymmetrical with respect to the light input edges 20, 22. The light extracting elements 24 are elongate in the sense that they are substantially longer in a direction normal to the light input edges 20, 22 than they are in a direction parallel to the light input edges 20, 22. The light extracting elements are asymmetrical in the sense that they appear differently when viewed from light input edge 20 than when viewed from light input edge 22. Each light extracting element 24 includes a primary surface portion and a secondary surface portion. The primary surface portion is smaller and more steeply sloped relative to the major surface at which the light extracting element is located than the secondary surface portion. In some embodiments, the first and second surface portions are respective portions of a continuous surface. In other embodiments, the first and second surface portions are distinct and intersect at an apex or a ridge. In some embodiments, the intersection is chamfered, beveled, or has another suitable shape. One or more of the surface portions of the light extracting elements may be modified, such as roughened, to produce a secondary effect on light output. The light extracting elements may vary in one or more of size, shape, depth or height, density, slope angle, or index of refraction such that desired spatial variations of light output from the light guide 14 are achieved over the one of the major surfaces 16, 18 through which light is extracted from the light guide.

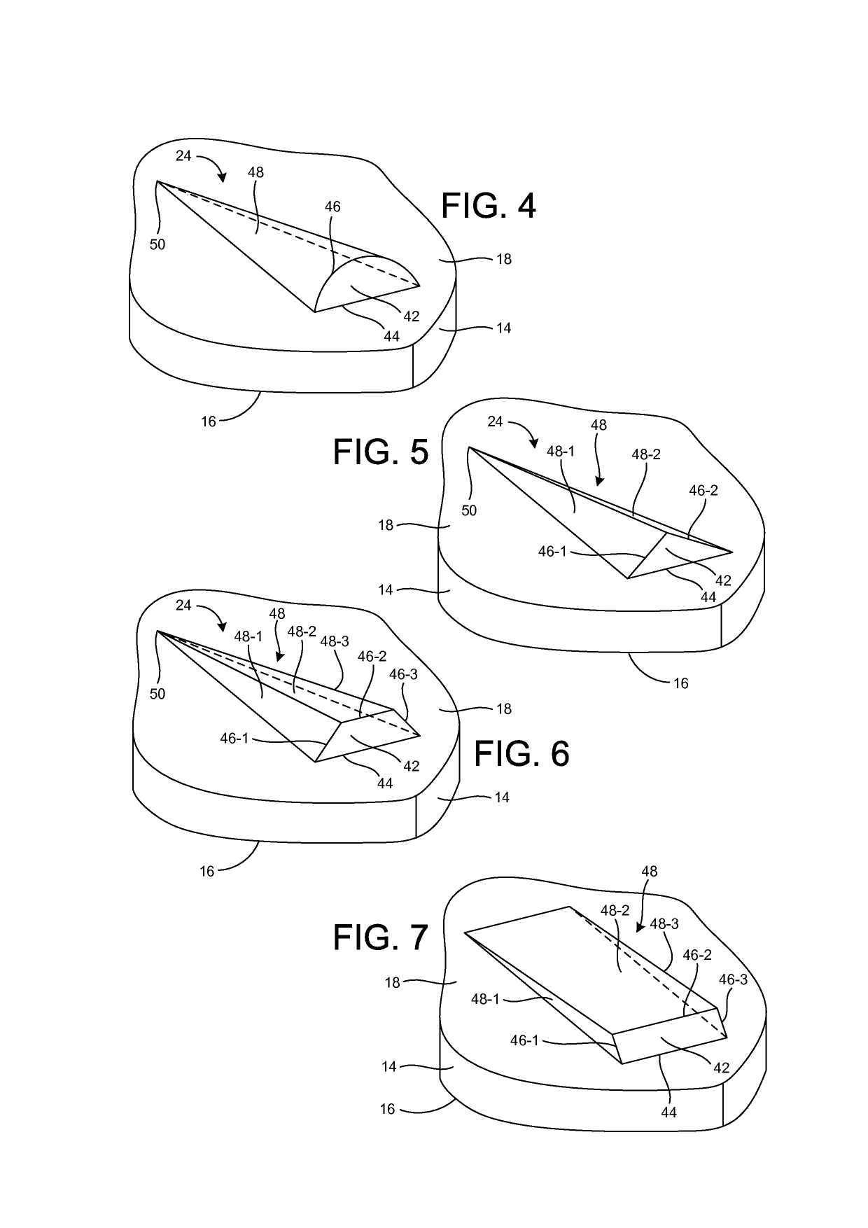

With additional reference to FIGS. 4 through 7, illustrated are exemplary embodiments of light extracting elements 24 configured to extract light from one of the light sources 30, 32 toward an appropriate one of the first location 34 or the second location 36. These light extracting elements 24 are further configured to disrupt the total internal reflection of light from the other of the light sources 30, 32 less than they disrupt the total internal reflection of the light from the one of the light sources 30, 32. Additionally or alternatively, the light extracting elements 24 are configured to extract light from the other of the light sources 30, 32 from the light guide 14 in directions away from the first and second locations 34, 36 so that the light they extract does not impair the viewer's perception of the autostereoscopic image 12. In these embodiments, the first light extracting elements 26 are configured to extract light from the first light source 30 toward the first location 34, and are additionally configured to disrupt the total internal reflection of light from the second light source 32 less than they disrupt the total internal reflection of the light from the first light source 30. Additionally or alternatively, the first light extracting elements 26 are configured to extract light from the second light source 32 from the light guide 14 in directions away from the first and second locations 34, 36. The second light extracting elements 28 are configured to extract light from the second light source 32 toward the second location 36, and are additionally configured to disrupt the total internal reflection of light from the first light source 30 less than they disrupt the total internal reflection of the light from the second light source 32. Additionally or alternatively, the second light extracting elements 28 are configured to extract light from the first light source 30 from the light guide 14 in directions away from the first and second locations 34, 36.

In some embodiments, at least some of the first light extracting elements 26 and the second light extracting elements 28 are arranged in interlocking patterns. In some embodiments, at least some of the first light extracting elements 26 and the second light extracting elements 28 are mirror images of one another.

In the representative illustrations of FIGS. 4-7, the embodiments of the light extracting element 24 are shown as protrusions from the second major surface 18 of the light guide 14. Other embodiments of the light extracting element 24 are protrusions from the first major surface 16 of the light guide (e.g., as shown in FIG. 3), or indentations into the light guide 14 from the first major surface 16 (not shown) or from the second major surface 18 (e.g., as shown in FIGS. 1 and 2).

In each of the embodiments of light extracting element 24 shown in FIGS. 4-7, the primary surface portion of the light extracting element 24 is provided by a primary surface 42 and the secondary surface portion of the light extracting element is provided by a secondary surface 48. The primary surface 42 extends relative to the second major surface 18 at an angle such that the primary surface 42 reflects light incident thereon toward a desired one of the locations 34, 36. The primary surface 42 and the second major surface 18 intersect at a first edge 44. The secondary surface 48 intersects the primary surface 42 at a second edge 46 and the secondary surface 48 intersects the second major surface 18. The secondary surface 48 is larger in surface area than the primary surface 42 and is angled relative to the second major surface 18 at a smaller angle than the primary surface 42.

In each embodiment shown in FIGS. 4-7, the primary surface 42 is planar and the first edge 44 is straight. In the embodiment shown in FIG. 4, the secondary surface 48 is curved and the second edge 46 is curved. The curved secondary surface 48, at its end distal the second edge 46, terminates at an apex region 50 on the second major surface 18. The light extracting element 24 tapers in two dimensions with increasing distance from the primary reflective surface 42 such that the light extracting element 24 progressively decreases in cross-sectional area in the direction from the second edge 46 to the apex region 50. In the example shown, in a direction parallel to the primary surface 42, the light extracting element 24 has a cross-sectional shape that is a segment of a circle. In other examples, the cross-sectional shape is a segment of an ellipse or a parabola. The cross-sectional shape may be truncated by a line parallel to the major surface 18.

The light extracting elements 24, configured as shown in FIG. 4, are oriented with their longitudinal axes nominally parallel to normals to the light input edges 20, 22.

In each of the embodiments shown in FIGS. 5-7, the primary surface 42 is a planar polygon, the secondary surface 48 is faceted, the first edge 44 is straight and the second edge 46 is segmented. The light extracting elements 24 configured as shown in FIGS. 5-7 are oriented relative to the light input edges 20, 22 similarly to the light extracting elements shown in FIG. 4.

In the embodiment shown in FIG. 5, the segmented second edge 46 has two segments 46-1 and 46-2 such that the primary surface 42 is triangular in shape. Also, the secondary surface 48 has two triangular planar facets 48-1 and 48-2. The planar facets 48-1 and 48-2, at their ends distal the second edge 46, terminate at an apex region 50 on the second major surface 18. The light extracting element 24 tapers in two dimensions with increasing distance from the primary surface 42. The light extracting element 24 progressively decreases in cross-sectional area in the direction from the second edge 46 to the apex region 50.

In the embodiment shown in FIG. 6, the segmented second edge 46 has three segments 46-1, 46-2 and 46-3 such that the primary surface 42 is quadrilateral in shape. In the example shown, the primary surface 42 is trapezoidal in shape. Also, the secondary surface 48 has three triangular planar facets 48-1, 48-2 and 48-3. The planar facets 48-1, 48-2 and 48-3, at their ends distal the second edge 46, terminate at an apex region 50 on the second major surface 18. The light extracting element 24 tapers in two dimensions with increasing distance from the primary surface 42 such that the light extracting element progressively decreases in cross-sectional area in the direction from the second edge 46 to the apex region 50.

In the embodiment shown in FIG. 7, the segmented second edge 46 has three segments 46-1, 46-2 and 46-3 such that the primary surface 42 is quadrilateral in shape. In the example shown, the primary surface 42 is rectangular in shape. Also, the secondary surface 48 has three planar facets 48-1, 48-2 and 48-3. The facet 48-2 is rectangular in shape and slopes from edge 46-2 to intersect the second major surface 18. As a result, the facet 48-2 of the embodiment shown in FIG. 7 has more surface area than the facet 48-2 of the embodiment shown in FIG. 6. The facets 48-1 and 48-3 are triangular in shape. The light extracting element 24 tapers in one dimension with increasing distance from the primary surface 42 such that the light extracting element 24 progressively decreases in cross-sectional area in the direction from the second edge 46 to the apex region 50.

The patterns of light reflected or transmitted by the primary surfaces 42 of the light redirecting elements 26, 28 are perceived as the autostereoscopic image. In the embodiment of FIG. 2 where the light extracting elements are indentations and the primary surface 42 of each light extracting element reflects a portion of the patterns of light perceived as the autostereoscopic image, the first light extracting elements 26 that reflect light from the first light source 30 are each oriented with the primary surface 42 thereof closer to the first light source 30 than the secondary surface 48 thereof. Similarly, the second light extracting elements 28 that reflect light from the second light source 32 are each oriented with the primary surface 42 thereof closer to the second light source 32 than the secondary surface 48 thereof. In this arrangement, the low profile of the secondary surface 48 tends not to interact with the propagating light, which reduces disruption to the total internal reflection of the light.

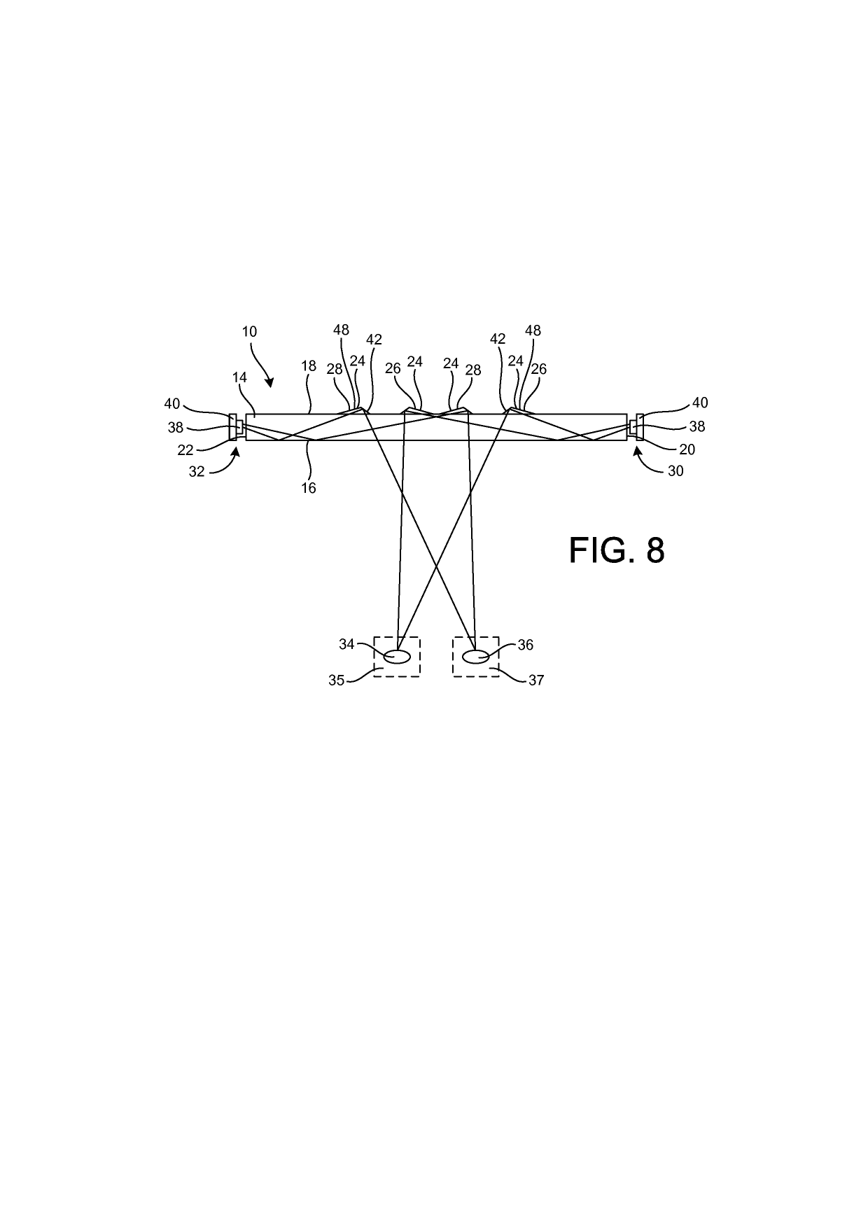

In the embodiment illustrated in FIG. 8, the light extracting elements 24 are protrusions. In this case, the first light extracting elements 26 that protrude and reflect light from the first light source 30 are oriented with the primary surface 42 thereof closer to the second light source 32 than the secondary surface 48 thereof. Similarly, the second light extracting elements 28 that protrude and reflect light from the second light source 32 are oriented with the primary surface 42 thereof closer to the first light source 30 than the secondary surface 48 thereof.

In one embodiment, to extract light from the light guide 14 with a spatial variation in intensity that produces the left eye version of the image at the first location 34, the first light extracting elements 26 are varied in one or more of size, shape, depth or height, density, orientation, slope angle, or index of refraction. Similarly, to extract light from the light guide 14 with a spatial variation in intensity that produces the right eye version of the image at the second location 36, the second light extracting elements 28 are varied in one or more of size, shape, depth or height, density, orientation, slope angle, or index of refraction.

In another embodiment, some of the light extracting elements 24 are protrusions and some of the light extracting elements 24 are indentations. For example, in one embodiment, the first light extracting elements 26 are indentations and the second light extracting elements 28 are protrusions. As another example, the first light extracting elements 26 are protrusions and the second light extracting elements 28 are indentations.

In this disclosure, the phrase “one of” followed by a list is intended to mean the elements of the list in the alternative. For example, “one of A, B and C” means A or B or C. The phrase “at least one of” followed by a list is intended to mean one or more of the elements of the list in the alternative. For example, “at least one of A, B and C” means A or B or C or (A and B) or (A and C) or (B and C) or (A and B and C).

What is claimed is:

1. A lighting assembly that forms a static autostereoscopic image, comprising:
a light guide having a first major surface and an opposed second major surface between which light propagates by total internal reflection, a first light input edge, a second light input edge opposite the first input edge, first light extracting elements at at least one of the major surfaces, and second light extracting elements at the at least one of the major surfaces;
a first light source that edge lights the light guide through the first light input edge; and
a second light source that edge lights the light guide through the second light input edge; wherein:
the light extracting elements are elongate and are asymmetrical with respect to the light input edges;
the first light extracting elements extract light from the first light source through the first major surface toward a first region as a first pattern of light;
the second light extracting elements extract light from the second light source through the first major surface toward a second region, different from the first region, as a second pattern of light; and
the first pattern of light extracted towards the first region and the second pattern of light extracted towards the second region, when viewed within the first region and the second region by the left eye and the right eye, respectively, of a viewer, are perceived as a static autostereoscopic image.

2. The lighting assembly of claim 1, wherein:
the first light extracting elements are configured to extract light from the first light source toward the first region, and to at least one of (a) disrupt the total internal reflection of the light from the second light source less than the total internal reflection of the light from the first light source, and (b) extract light from the second light source from the light guide in directions away from the first region and the second region; and
the second light extracting elements are configured to extract light from the second light source toward the second region, and to at least one of (a) disrupt the total internal reflection of the light from the first light source less than the total internal reflection of the light from the second light source, and (b) extract light from the first light source from the light guide in directions away from the first region and the second region.

3. The lighting assembly of claim 1, wherein:
the first light extracting elements are configured to extract light from the first light source toward the first region, and to disrupt the total internal reflection of the light from the second light source less than the total internal reflection of the light from the first light source; and
the second light extracting elements are configured to extract light from the second light source toward the second region, and to disrupt the total internal reflection of the light from the first light source less than the total internal reflection of the light from the second light source.

4. The lighting assembly of claim 1, wherein:
the first light extracting elements are configured to extract light from the first light source toward the first region, and to extract light from the second light source from the light guide in directions away from the first region and the second region; and
the second light extracting elements are configured to extract light from the second light source toward the second region, and to extract light from the first light source from the light guide in directions away from the first region and the second region.

5. The lighting assembly of claim 1, wherein each light extracting element is at the second major surface, and comprises:
a primary surface portion extending relative to the second major surface and angled relative to the second major surface to reflect light toward the respective region; and
a secondary surface portion extending between the primary surface portion and the second major surface, the secondary surface portion larger in surface area than the primary surface portion and having a smaller angle relative to the second major surface than the primary surface portion

6. The lighting assembly of claim 5, wherein:
the first light extracting elements are indentations in the second major surface, and are oriented with the primary surface portion thereof closer to the first light source than the secondary surface portion thereof; and
the second light extracting elements are indentations in the second major surface, and are oriented with the primary surface portion thereof closer to the second light source than the secondary surface portion thereof.

7. The lighting assembly of claim 5, wherein:
the first light extracting elements are protrusions from the second major surface, and are oriented with the primary surface portion thereof closer to the second light source than the secondary surface portion thereof and
the second light extracting elements are protrusions from the second major surface, and are oriented with the primary surface portion thereof closer to the first light source than the secondary surface portion thereof.

8. The lighting assembly of claim 5, wherein the secondary surface portion of at least some of the light extracting elements is curved.

9. The lighting assembly of claim 5, wherein the secondary surface portion of at least some of the light extracting elements is faceted.

10. The lighting assembly of claim 5, wherein at least some of the light extracting elements taper with increasing distance from the primary surface portion.

11. The lighting assembly of claim 10, wherein at least some of the light extracting elements taper in two dimensions with increasing distance from the primary surface portion.

12. The lighting assembly of claim 1, wherein at least some of the first light extracting elements and the second light extracting elements are mirror images of one another.

13. The lighting assembly of claim 1, wherein the first light extracting elements are indentations in the one of the major surfaces, and the second light extracting elements are protrusions from the one of the major surfaces.

14. The lighting assembly of claim 1, wherein the first and second light sources comprise solid-state light emitters.

15. The lighting assembly of claim 14, wherein the first and second light sources comprise light emitting diodes.

16. The lighting assembly of claim 1, wherein:
the first light extracting elements are varied in one or more of size, shape, depth or height, density, orientation, slope angle, or index of refraction to extract the light from the first light source from the light guide with a spatial variation in intensity that produces the first pattern of light; and
the second light extracting elements are varied in one or more of size, shape, depth or height, density, orientation, slope angle, or index of refraction to extract the light from the second light source from the light guide with a spatial variation in intensity that produces the second pattern of light.

17. A lighting assembly that forms a static autostereoscopic image, comprising:
a light guide having a first major surface and an opposed second major surface between which light propagates by total internal reflection, a first light input edge, a second light input edge opposite the first input edge, first light extracting elements at at least one of the major surfaces, and second light extracting elements at the at least one of the major surfaces;
a first light source that edge lights the light guide through the first light input edge; and
a second light source that edge lights the light guide through the second light input edge; wherein:
the light extracting elements are elongate and are asymmetrical with respect to the light input edges;
the first light extracting elements are configured to extract light from the first light source through the first major surface toward a first region as a first pattern of light having a spatial variation of intensity that produces a first image of a stereoscopic pair of images; and
the second light extracting elements are configured to extract light from the second light source through the first major surface toward a second region, different from the first region, as a second pattern of light having a spatial variation of intensity that produces a second image of the stereoscopic pair of images.

18. The lighting assembly of claim 17, wherein:
the first light extracting elements are varied in one or more of size, shape, depth or height, density, slope angle, or index of refraction to extract the light from the first light source as the first pattern of light having the spatial variation in intensity that produces the first image; and
the second light extracting elements are varied in one or more of size, shape, depth or height, density, slope angle, or index of refraction to extract the light from the second light source as the second pattern of light having the spatial variation in intensity that produces the second image.

19. A lighting assembly that forms a static autostereoscopic image, comprising:
a light guide having a first major surface and an opposed second major surface between which light propagates by total internal reflection, a first light input edge, a second light input edge opposite the first input edge, and light extracting elements at at least one of the major surfaces;
a first light source that edge lights the light guide through the first light input edge; and
a second light source that edge lights the light guide through the second light input edge; wherein:
the light extracting elements are elongate and are asymmetrical with respect to the light input edges;
the light extracting elements extract light from the first light source through the first major surface toward a first region and extract light from the second light source through the first major surface toward a second region, different from the first region; and
the light extracted towards the first region and the light extracted towards the second region form respective patterns of light that, when viewed within the first region and the second region by the left eye and the right eye, respectively, of a viewer, are perceived as a static autostereoscopic image.
